(19) United States
(12) Patent Application Publication
(10) Pub. No.: US 2015/0105103 A1
(43) Pub. Date: Apr. 16, 2015

(54) METHODS NODES AND COMPUTER PROGRAM FOR POSITIONING OF A DEVICE

(71) Applicant: NiDa Tech Sweden AB, Malmo (SE)

(72) Inventor: Håkan DACKEFJORD, Alvsjo (SE)

(21) Appl. No.: 14/578,532

(22) Filed: Dec. 22, 2014

Related U.S. Application Data
(63) Continuation of application No. PCT/SE2013/050874, filed on Jul. 5, 2013.
(60) Provisional application No. 61/715,165, filed on Oct. 17, 2012.

(30) Foreign Application Priority Data
Jul. 6, 2012 (SE) 1250786-9
Oct. 16, 2012 (SE) 1251171-3
Apr. 3, 2013 (SE) 1350260-4

(51) Int. Cl. H04W 64/00; G01S 5/00

(52) U.S. Cl. CPC H04W 64/00; G01S 5/0063
USPC 455/456.2

(57) ABSTRACT

A method in a mobile node for enabling determination of a position of a device. The method comprises receiving a positioning request message, including an identification of the device. The method further comprises transmitting an alert signal to the device, including the identification of the device. The method further comprises receiving a response signal from the device, including the identification of the device. The method further comprises calculating a distance or a direction to the device by measuring the received response signal, thereby enabling of determination of the position of the device.

### TECHNICAL FIELD

The present invention relates generally to methods, nodes, computer program and a computer program product for positioning of a device.

### BACKGROUND ART

It is known to identify the geographical position of mobile devices, such as cellular telephones, PDAs etc., by the aid of so-called triangulation. The approximate localization of the mobile devices is defined via the sensing of signal strength of the radio of at least three radio towers, i.e. base stations, of the network of the mobile device. Other positioning methods, such as Cell ID, CGI/TA, E-CGI and A-GPS are also available.

It is further known to identify the position of lost or stolen objects by the aid of GPS positioning means. Objects may hereby be equipped with preferably concealed GPS trackers, i.e. GPS receivers, which are actuatable by a center station or a user via radio communication to collect positioning data for the object from GPS satellites. Such tracker is known from for instance GB2483459 A or GB2484273 A. A drawback with these types of trackers is that they require a costly mobile phone subscription and a configuration of for instance a GSM modem and GPS receiver devices. Said devices are highly energy consuming and therefore need to be equipped with relatively bulky batteries which requires constant charging and operator discipline in terms of shutting the GPS tracker on and off to work as intended. The increased cost, size, weight and bulkiness further reduces the GPS trackers usability for certain applications wherein such parameters are preferably kept low, e.g. to track stolen bicycles, vehicles etc. For instance, it is generally not feasible to track objects of relatively low cost compared to the GPS trackers themselves, and a single user may not be able to afford to equip all objects he desires with expensive GPS trackers. Some objects, such as for instance bicycles or motorbikes are stolen in large volumes, generating high costs not only for the owners but further to the insurance companies. A further drawback is that a stolen or lost object to be tracked by using a GPS tracker may be positioned such that their ability to receive either GPS signals or signals via the mobile network is highly reduced, whereby their tracking ability is incapacitated.

### SUMMARY OF INVENTION

An object of the present solution is to alleviate some of the disadvantages of the prior art and to provide an improved device for positioning objects which is cheaper during use and manufacture and can be kept smaller in size.

A further object of the present solution is to provide an improved device for positioning objects which is more reliable and robust.

According to one embodiment, a method in a mobile node is provided for enabling determination of a position of a device, the method comprising:
receiving a positioning request message, including an identification of the device,
transmitting an alert signal to the device, including the identification of the device,
receiving a response signal from the device, including the identification of the device, and
calculating a distance or a direction to the device by measuring the received response signal, thereby enabling of determination of the position of the device.

According to another embodiment, a method is provided, wherein
the positioning request message, including an identification of the device is received from a remote node.

According to another embodiment, a method is provided, wherein
a response to the positioning request message including the calculated distance or a direction to the device and a position of the mobile node, is transmitted to the remote node.

According to another embodiment, a method is provided, wherein
the distance to the device is calculated by measuring the signal strength or signal delay.

According to another embodiment, a method is provided, wherein
the direction to the device is calculated by determination of a bearing to a strongest signal strength.

According to another embodiment, a method is provided, wherein
the node receives the response signal from the device in a first receiving device and a second receiving device, wherein the second receiving device is a microphone device.

According to another embodiment, a method is provided, wherein
the microphone device further receives a sound signal from the device.

According to another embodiment, a method is provided, wherein
the node receives the response signal from the device in a third receiving device, wherein the third receiving device is a separate antenna device mountable to the mobile node.

According to another embodiment, a method is provided, wherein
the method is repeatedly carried out.

According to another embodiment, a method in a device for enabling determination of a position of the device by a mobile node is provided, the method comprising:
receiving an alert signal from the mobile node, including an identification of the device,
alerting the device by matching the received identification with a pre-programmed identification of the device,
transmitting a response to the alert signal, including the identification of the device matching said received identification, thereby enabling determination of the position of the device.

According to another embodiment, a method is provided, wherein
the response to the alert signal is repeatedly transmitted.

According to another embodiment, a method in a remote node (120) for determination of a position of a device is provided, the method comprising:
transmitting a positioning request message, including an identification of the device, to a plurality of mobile nodes,
receiving at least one response to the positioning request message, including a calculated distance to the device from the mobile node, and a position of the mobile node,
determining a position of the device by calculation of the distance of the device from the mobile node in combination with the position of the at least one mobile device.
According to another embodiment, a method is provided, wherein the position of the device is determined whether within a predefined geographical area or volume and/or whether the position of the device is within a predefined distance from a geographical point.

According to another embodiment, a method is provided, wherein
an alarm message is transmitted to an alarm device upon determining that the position of the device is outside the predefined geographical area or volume and/or whether the position of the device is beyond the predefined distance from the geographical point.

According to another embodiment, a method is provided, wherein
the alarm device comprises at least one of the remote node, the mobile node or the device.

According to another embodiment, a method is provided, wherein
the geographical point is defined by the location of a mobile node.

According to another embodiment, a method is provided, wherein
the positioning request message is repeatedly transmitted.

According to another embodiment, a method is provided, wherein
when responses to the positioning request messages are received from a plurality of mobile nodes, the position of the device is calculated by use of any of triangulation, or multilateration, or trilateration.

According to another embodiment, a method is provided, wherein
the remote node is hosted by a mobile node.

According to an embodiment a mobile node is arranged to enable determination of a position of a device, wherein:
the mobile node is arranged to receive a positioning request message, including an identification of the device,
the mobile node is arranged to transmit an alert signal to the device, including the identification of the device,
the mobile node is arranged to receive a response signal from the device, including the identification of the device, and
the mobile node is arranged to calculate a distance or a direction to the device by measuring the received response signal, thereby enabling of determination of the position of the device.

according to an embodiment a device is arranged to enable determination of a position of the device by a mobile node, wherein:
the device is arranged to receive an alert signal from the mobile node, including an identification of the device,
the device is arranged to alert the device by matching the received identification with a pre-programmed identification of the device,
the device is arranged to transmit a response to the alert signal, including the identification of the device matching said received identification, thereby enabling determination of the position of the device.

According to an embodiment is a remote node arranged to determine a position of a device, wherein:
the remote node is arranged to transmit a positioning request message, including an identification of the device, to a plurality of mobile nodes,
   the remote node is arranged to receive at least one response to the positioning request message, including a calculated distance to the device from the mobile node, and a position of the mobile node,
   the remote node is arranged to determine a position of the device by calculation of the distance of the device from the mobile node in combination with the position of the at least one mobile device.

According to an embodiment a computer program, comprising computer readable code means, which when run in a mobile node arranged to enable determination of a position of a device, causes the mobile node arranged to enable determination of a position of a device to perform the corresponding method.

The above methods and nodes and computer program may be configured and implemented according to different optional embodiments.

### BRIEF DESCRIPTION OF DRAWINGS

The invention is now described, by way of example, with reference to the accompanying drawings, in which:

FIG. 1 is an overview of a positioning solution.

FIG. 2 is an overview illustrating embodiments of a positioning solution.

FIG. 3 is flow chart illustrating a procedure in a mobile node.

FIG. 4 is a flow chart illustrating a procedure in a device.

FIG. 5 is a flow chart illustrating a procedure in a remote node.

FIG. 6 is a block diagram illustrating further embodiments of a positioning solution.

FIG. 7 is a block diagram illustrating further embodiments of a positioning solution with a computer environment.

FIG. 8A-C shows illustrations of a distance and an area.

FIG. 9 shows an illustration of relocation of a mobile node.

FIG. 10 shows an illustrating signaling diagram according to some embodiments.

FIG. 11 illustrates example embodiments of a device.

### DESCRIPTION OF EMBODIMENTS

In the following, a detailed description of the invention will be given. In the drawing figures, like reference numerals designate identical or corresponding elements throughout the several figures. It will be appreciated that these figures are for illustration only and are not in any way restricting the scope of the solution.

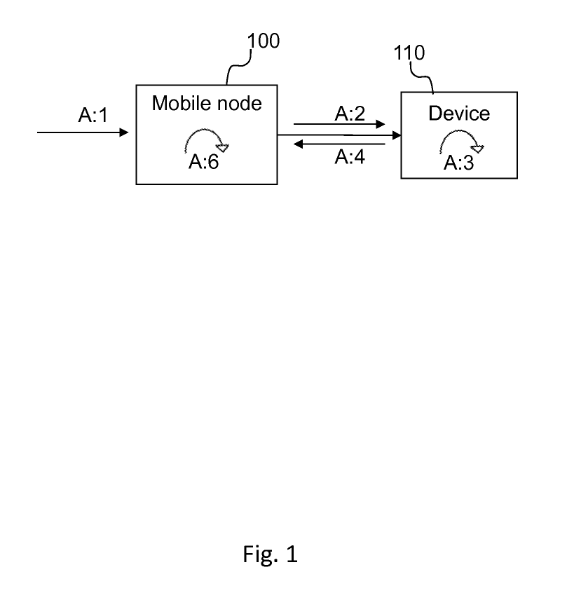

FIG. 1 shows an overview of a positioning system comprising a mobile node 100, wherein the mobile node 100 may comprise one of e.g. the following: a mobile phone, a smart phone, a tablet PC, ADSL router, wireless LAN access device (Local Area Network), fiber-to-the-home termination device, access point for wireless device, mobile terminal, vehicle arranged terminal, home automation access unit, TV set top box, and similar network access points, not limiting to other units. The positioning system further comprises a device 110 to be positioned. The device 110 may comprise for instance any of mobile phone, wireless LAN access device, access point for wireless device, mobile wireless LAN access device, an RFID device (Radio Frequency Identification), a Bluetooth device, a ZigBee device, not limiting to other units. The device 110 may be arranged on other device that is to be positioned. As can be seen in FIG. 1, the mobile node is arranged to receive a positioning request message (A:1) including an identification of the device 110. According to an embodiment, the positioning request message (A:1) may be sent from a remote node 120 comprising for instance a mobile node 100, a mobile device, a personal computer, a web site, a virtual network client, a server, or any other kind of network connected unit, from which it is possible to communicate with a mobile node 100. The mobile node 100 is further arranged to transmit an alert signal (A:2) to the device 110, including the identification of the device 110, to receive a response signal (A:4) from the device 110, including the identification of the device 110 and for calculating (A:6) a distance or a direction to the device 110 by measuring the received response signal, thereby enabling of determination of the position of the device 110. The identification may be for example a MAC-address (Media Access Control), a SSID (Service Set Identifier), an e-mail address, a SIP-address (Session Initiation Protocol), an IP-address (Internet Protocol), a URL (Uniform Resource Locator) or a URI (Uniform Resource Identifier), not limiting other types if identifications to be used. The signal may be for example sent via TCP/UDP IP (Transfer Control Protocol/User Datagram Protocol/Internet Protocol), Wireless LAN, http (Hypertext Transfer protocol), https (http secure), as a SIP-message, or an e-mail, not limiting other suitable protocols for carrying the signal.

According to one embodiment, the mobile node 100 is arranged to calculate the distance to the device 110 by measuring the signal strength or signal delay. This is often referred to as positioning, or tracking, or localization of a device transmitting a signal, a signal which is possible to detect. According to an embodiment, the mobile node 100 is arranged to calculate the direction to the device 110 by determination of a bearing to a strongest signal strength.

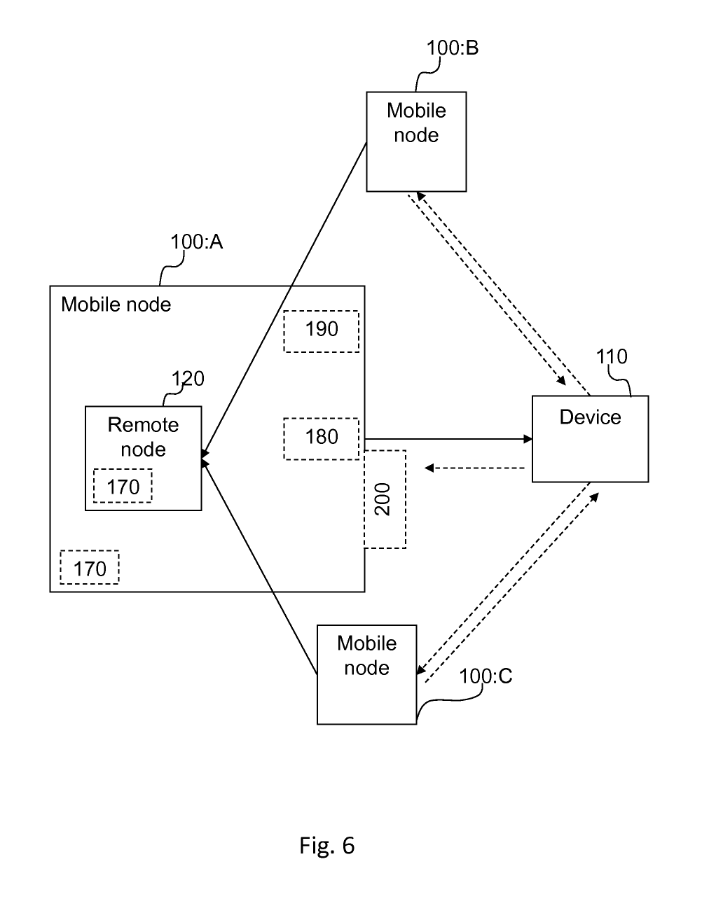

According to one embodiment, the mobile node 100 is arranged to receive the response signal from the device 110 in a first receiving device 180 and a second receiving device 190. The alarm device 170, first receiving device 180, the second receiving device 190 and third receiving device 200 are shown in FIG. 6. According to one embodiment, the first receiving 180 device is an antenna device. According to one embodiment the second receiving device 190 is a microphone device. In another embodiment, the second receiving device may be a camera. According to one embodiment, the microphone device is arranged to determine the bearing to a strongest signal strength of the response signal. The response signal may, in one embodiment, be an electromagnetic signal. According to one embodiment, the response signal may comprise a sound signal. A second receiving device 190 may be used to further enhance the ability and/or accuracy in determining the distance and direction to the device 110. In one embodiment, the mobile node 100 is arranged to receive a response signal from the device 110 in a third receiving device 200, wherein the third receiving device is a separate antenna device mountable to the mobile node 100. A third receiving device 200 may be used to further enhance the ability and/or accuracy in determining the distance and direction to the device 110.

According to an embodiment, the mobile node 100 is arranged to transmit a response to the positioning request message (A:1) to the remote node 120, including the calculated distance or a direction to the device 110. In an embodiment, the response message also includes the a position of the mobile node 100. The position of the mobile node 100 may be determined by the mobile node 100 by being arranged with and using a GPS receiver, A-GPS functionality, Wifi enhanced GPS functionality or other enhanced GPS positioning techniques or being arranged to use triangulation, trilateration or multilateration using a mobile network.

If a mobile network is used for positioning o the mobile node 100, the position of the mobile node 100 may be provided by the mobile network.

Further, in the positioning system of FIG. 1, the device 110 is arranged to receive an alert signal from the mobile node 100 including an identification of the device 110, alerting the device 110 by matching the received identification with a preprogrammed identification of the device 110, transmitting a response to the alert signal, including the identification of the device 110 matching said received identification, thereby enabling determination of the position of the device 110. According to an embodiment, the device 110 is adapted to repeatedly transmit the response to the alert signal. Hereby, a risk that for instance a remote node 120 does not receive the response due to poor signal strength/connectivity resulting e.g. from the position of the device 110 or the mobile node 100 may be reduced. Another advantage may be, if the device 110 changes location, it may be possible to determine the new position.

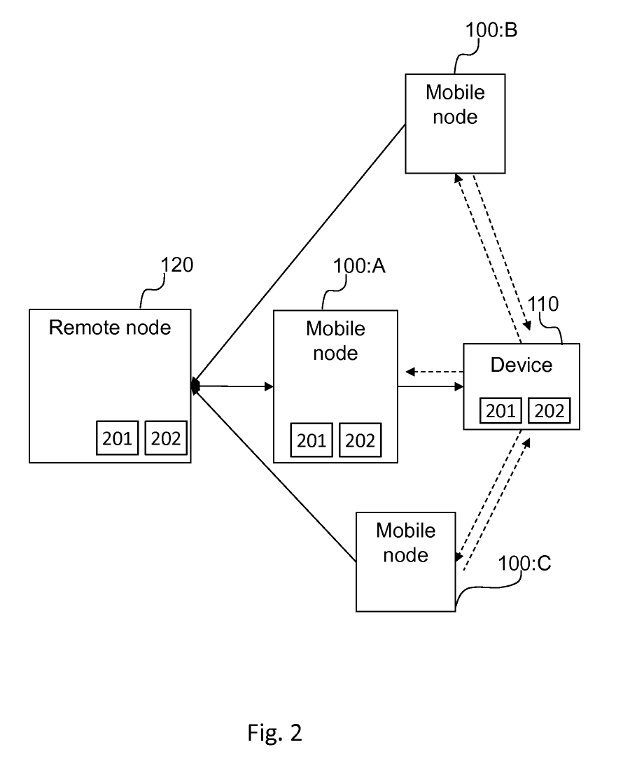

FIG. 2, shows an overview of the positioning system, comprising a plurality of mobile nodes 100. The positioning system further comprises a remote node 120 comprising for instance a mobile node 100. The remote node 120 is arranged to transmit a positioning request message, including an identification of the device 110, to a plurality of mobile nodes 110. Such plurality of mobile nodes may be a closed user group of users which have agreed to use a specific service, a random group of mobile nodes 100 located in the vicinity of the remote node 120, an open user community which users may subscribe to, an ad hoc network, or a meshed network, or similar. The remote node 120 is further arranged to receive at least one response to the positioning request message, including a calculated distance to the device 110 from the mobile node 100, and a position of the mobile node 100 as well as determining a position of the device 110 by calculation of the distance of the device 110 from the mobile node 100 in combination with the position of the at least one mobile device 100. In one embodiment, the remote node 120 is arranged to calculate the position of the device 110 using any of triangulation, multilateration or trilateration upon receiving responses to the position request message from a plurality of mobile nodes 110. According to an embodiment, the remote node 120 is hosted by a mobile node 100, i.e. the remote node 120 may itself be used to the determined the position of the device 110.

As may further be seen in FIG. 2, in an embodiment, the nodes 100, 110, and 120 comprises a processing unit 201 for execution of instructions of computer program software, according to FIG. 6. The figure further shows a memory unit 202 for storage of a computer program software and cooperation with the processing unit 201. Such processing unit 201 and memory unit 202 may be provided by a general purpose computer, or a computer dedicated for the nodes 100, 110, and/or 120.

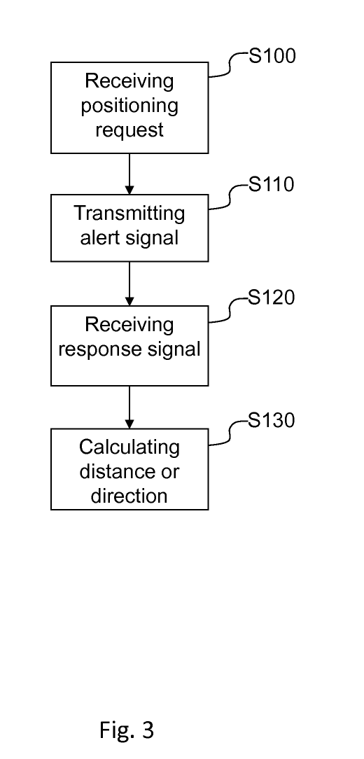

A procedure or method in a mobile node, for example a mobile node 100 of the positioning system for enabling determination of a position of a device will now be described with reference to FIG. 3. In a first step S100, a positioning request message, including the identification of device 110 is received in a mobile node 100. The positioning request message may for instance be received from a remote node 120. In a next step S110, the mobile node 100 transmits an alert signal to the device 110, including the identification of the device 110. In a next step S120, the mobile node 100 receives a response signal from the device 110, including the device 110. In step S130, a calculation of a distance or direction to the device 110 is carried out in the mobile node 100 by measuring the received response signal, thereby enabling of determination of the position of the device 110. In a further possible step according to one embodiment, a response to the positioning request message including the calculated distance or a direction to the device 110 and a position of the mobile node 100 is transmitted to the remote node 120. According to one embodiment, the distance to the device 110 is calculated by measuring the signal strength or signal delay. According to one embodiment, the direction to the device 110 is calculated by determination of a bearing to a strongest signal strength.

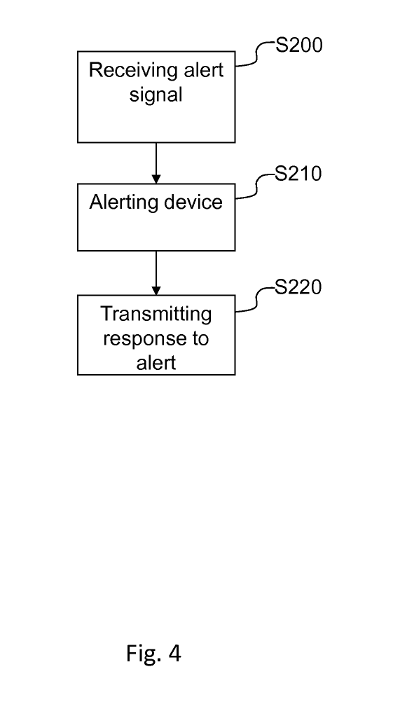

FIG. 4 shows a procedure or method performed in a device, for example a device 110 for enabling determination of a position of the device 110 by a mobile node 100. In a first step S200, the device receives an alert signal from the mobile node 100, including an identification the device 110. In a next step 210, the device 110 is alerted by matching the received identification with a preprogrammed identification of the device 110. In step 220, the device transmits a response to the alert signal, including the identification of the device 110 matching said received identification, thereby enabling determination of the position of the device 110. According to one embodiment, the response to the alert signal is repeatedly transmitted.

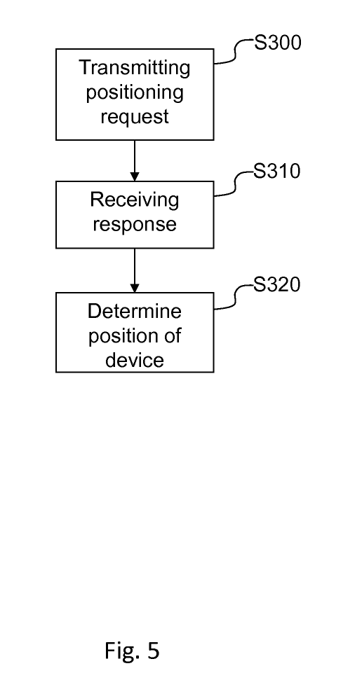

FIG. 5 shows a procedure or method performed in a remote node, for example a remote node 120 for determination of a position of a device 110. In a first step S300, a positioning request message is transmitted, including an identification of the device 110, to a plurality of mobile nodes 110. In a next step S310, the remote node 120 receives at least one response to the positioning request message, including a calculated distance to the device 110 from the mobile node 100, and a position of the mobile node 100. In step S320, determining a position of the device 110 by calculation of the distance of the device 110 from the mobile node 100 in combination with the position of the at least one mobile device 100 is carried out in the remote node 120. According to one embodiment, when responses to the positioning request messages are received from a plurality of mobile nodes 110, the position of the device 110 is calculated by use of any of triangulation, multilateration, or trilateration. According to one embodiment, the remote node 120 is hosted by a mobile node.

In an embodiment, not shown in the figures, an illustrative procedure may comprise the following steps. An object like a property, merchandise, or a person is provided with a device, such as the device 110, i.e. the device is associated with the object. At this stage, the device is passive and may only receive signals. At a given point a user wants to locate the object, with the device associated. That may be, for example, when a specific object has been stolen, or lost, a person may be anticipated as missing. The user may via a remote node register an instruction, which includes an instruction to start positioning. The remote node may than initiate positioning, by transmission of a positioning request to mobile nodes. Mobile nodes that are reached by the request, may than in turn transmit an alert signal to the device, the device associated with the object desired to locate. A user of the mobile nod may not need to be aware of the communication with a remote node or a device. The device may be activated. Mobile nodes in the vicinity of the device may be able to position the device, or at least measure a signal, the device associated with the object desired to locate. The received signal and position of the mobile node, may be transmitted by the mobile node to the remote node, wherein the remote node may be able to determine the position of the device, associated with the object, such that the user may be able to locate the stolen, lost or missing object.

FIG. 6 shows a block diagram illustrating embodiments of the solution with mobile nodes 100, device 110 and remote node 120. The remote node 120 may be comprised by one of the mobile nodes 100.

The remote node 120 may be an application arranged to operate in a mobile node 100, for example mobile node 100:A. In an example where the remote node 120 is arranged to operate in such an environment, the remote node 120 may be capable of utilizing positioning capabilities of the mobile node 100:A, which the remote 120 is installed on. The remote node 120 may further be capable to communicate with neighboring mobile nodes, such as mobile node 100:B and 100:C. The mobile nodes 100:B and 100:C may be in the vicinity of the mobile node 100:A, or may be remotely located relative to the mobile node 100:A including the remote node 120. Thereby may the remote node 120 be enabled to communicate with both the mobile node 100:A as well as the mobile nodes 100:B and 100:C, such that the remote node 120 may be capable to transmit positioning requests messages and receive responses to the positioning requests messages.

The remote node 120 may be arranged to communicate internally with the environment of the mobile node 100:A via standard API's (Application Programming Interfaces) suitable for transmission of positioning requests messages and reception of responses, or other suitable techniques provided by for example Java or Android. For communication between the remote node 120 and the mobile nodes 100:B and 100:C, different communication means may be used, for example PAN (Personal Area Network) provided by Bluetooth. Another example is WLAN (Wireless Local Area Network) provided by WiFi. Another example is communication based on TCP/UDP/IP (Transfer Control Protocol/user Datagram Protocol/Internet Protocol) via direct communication or provided via Internet connections for each of the nodes.

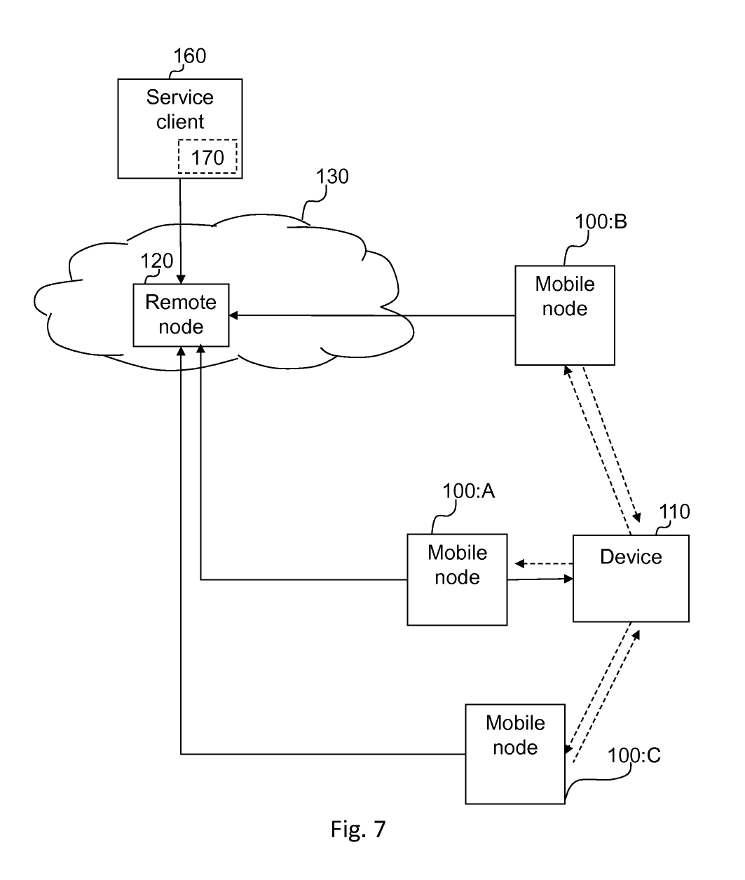

FIG. 7 shows an illustration of embodiments with the mobile nodes 100, device 110, remote node 120, a computer environment 130 for operation of a remote node 120 and a service client 160 for using of a positioning service.

The remote node 120 may be arranged in the computer environment 130. Examples of computer environments are, network connected computer, application server, web server, data facility, computer cloud, hosting service, not limiting the term computer environment to other suitable terms for a computer environment 130. The computer environment 130 may be arranged such that the remote node 120 may be enabled to communicate with mobile nodes 100. The communication may be performed over the public Internet, or a virtual private network over the Internet, or a closed TCP/IP-network, or an operator/service provider specific network for positioning services, not limiting the solution to use other types of networks.

In an example where the remote node 120 is centrally located in a computer environment 130, such that it may be enabled to communicate with mobile nodes 100 and thereby enabled to position a device 110, user of the solution may not practically have direct access to the remote node 120. Therefore a user of the solution may use a service client 160 to access the remote node 120. Examples of a service client 160 may be a web browser, a mobile application installed on a mobile device, or a dedicated client application for accessing a remote node 120, not limiting other client solutions. A user of the solution may via the service client 160 request positioning of a lost or stolen item, by requesting the position of or distance to the device 110 attached to the mentioned item. An example of usage may look according to the following. The user requests positioning by usage of the service client 160. The id of the device 110 may be entered as part of the request. A user may only be allowed to request a position of a device 110, by knowing the id of the device 110. A user may be authorized by some kind of AAA-solution (Authentication Authorization Accounting) known by the person skilled in the art, and outside the scope of this solution.

The service client 160 may communicate with the remote node 130 via http, https, or other suitable protocol. The remote node 130 may transmit a positioning request message, including the id, to at least one of the mobile node (100:A, 100:B, 100:C). The mobile nodes (100:A, 100:B, 100:C) may transmit the alert signal to the device 110. The device 110 may receive the alert signal, including the id. By matching the received id, with a pre-programmed id, the device 110 may be alerted. All mobile nodes 100 may not reach the device 110, with the alert signal. If a device 110 receives an alert signal with an id not matching the pre-programmed id, the device 110 may ignore the alert signal.

The alerted device 110 may transmit the response to the alert signal, including the id, such that the mobile nodes may calculate the distance and/or direction the device 110. The calculated distance and/or direction may be transmitted to, or retrieved by the remote node 120, including the position of the mobile node 100. The remote node 120 may use the distance and/or direction to the device 100 and the position of the mobile node 100 determine a position of the device 110.

The remote node 120 may present the position of the device 110 as graphical presentation accessible by the service clients 160, such as a direction from the service client 160 towards the device 110, or present a location of the device 110 on a map, not limiting other types of presentations.

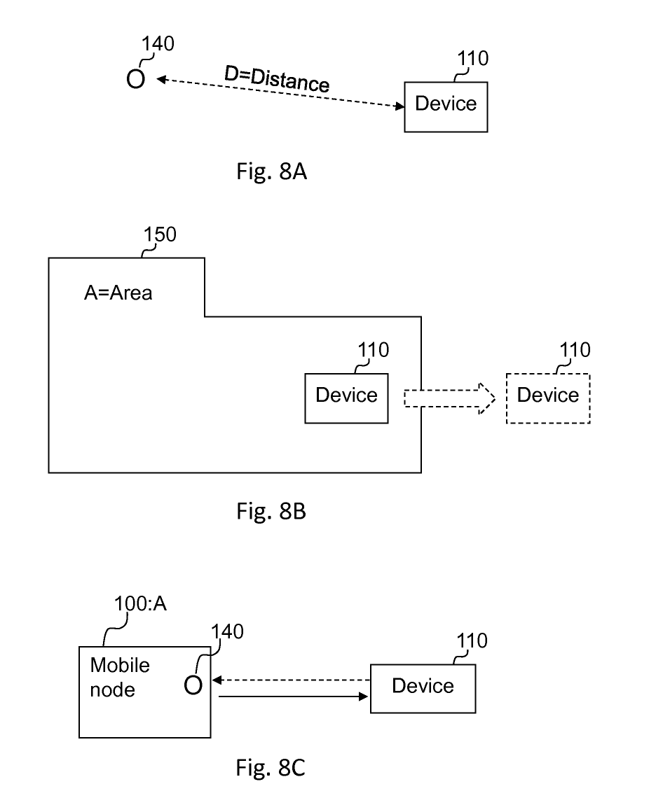

FIG. 8a shows a block diagram over a situation wherein a device 110 is at a certain distance from a geographical point 140. The remote node 120 may be arranged to determine whether the position of the device 110 is within a predefined distance D from the geographical point 140, or if the device 110 is outside the predetermined distance. According to one embodiment, the remote node 120 determines the position by comparing the position of the device 110 with a set geographical point 140 and calculates the distance between them. According to another embodiment as is further disclosed in FIG. 8c, the geographical point 140 is defined by the location of a mobile node 100. The position of the mobile node 100 may be dynamic.

FIG. 8b shows a block diagram over a situation wherein a device 110 is moved from a first position within a predefined geographical area 150 to a second position represented by the dashed line outside the predefined geographical area 150. By adding a coordinates in a third dimension to the geographical area 140, this may be considered as a geographical volume (not shown). The remote node 120 may be arranged to determine whether the position of the device 110 is within the geographical area 140 or volume. According to one embodiment, the remote node 120 determines the position by comparing the position of the device 110 with a set of acceptable positions within or on the boundary of the geographical area 140 or volume. According to various embodiments the geographical area 150 may be determined by a user indicating on a map the area which should be determined as inside or outside, or indicate boundaries on the map. A user may also indicate coordinates in a coordinate system, as a way to determine the geographical area 150, not limiting other suitable way of determining an area or a volume.

The remote node 120 is further arranged to transmit an alarm message to an alarm device (170) upon determining that the position of the device 110 is outside the predefined geographical area 150 or volume and/or whether the position of the device 110 is beyond a predefined distance D from a geographical point 140 which may be comprised by a mobile node 100. According to one embodiment, the alarm device 170 comprises at least one of the remote node 120, the mobile node 100 or the device 110. According to one embodiment, the remote node 120 is arranged to repeatedly transmit a positioning request message to a plurality of mobile nodes 100 in order to continuously determine the position of the device 110.

This will for instance enable a continuous tracking of one or a plurality of devices 110 from e.g. a remote node 120, 130 hosted by a mobile node 100, or from a service client 160 wherein the alarm message will warn a user of the mobile node 100, service client 160 or a person equipped with a device 110 if the device 110 is transported beyond an allowed geographical point 140, area 150 or volume. For instance, the geographical point 140 when defined by the mobile node 100 may be corresponding to a cellular phone carried by a parent and the device 110 may be carried by a child, such that the device is associated with the child, which is not allowed to be further away from the parent than a predefined distance D. According to another embodiment, the geographical area 150 or volume may correspond to the area of or volume around a building site and devices 110 may be arranged to tools within the building site such that each device is associated with a tool which is not allowed to leave the building site.

In the following a few examples of positioning techniques is described. The examples are for illustration of how a device 110 may be determined in direction, distance, and/or position. These examples are not limiting other techniques to be used.

Closest mobile node 100. The most basic of the location determination techniques, is to identify the location based on the mobile node 100 that is closest to the device 110. This may be done by looking at the association between the device 110 and the mobile node 100 or by measuring signal strength.

Calculation of the approximately distance between the client device 110 and one or more mobile nodes 100. This technique is called lateration. The distance may be calculated based on signal strength or timing information.

Received Signal Strength Indication (RSSI)—Signal strength is a measurement on how strongly a transmitted signal is being received at a particular distance from the transmitter. The signal strength varies with distance, obstacles and interfering radio frequency signals. Multi path fading also affect the signal strength. In Wi-Fi networks, the signal strength is defined as Received Signal Strength Indication (RSSI). RSSI may be measured by the mobile node 100 Link Quality Indicator (LQI) is a metric of the current quality of the received signal. The LQI may provide an estimate of how easily a received signal may be demodulated by accumulating the magnitude of the error between ideal constellations and the received signal over the 64 symbols immediately following the sync word.

Time Difference of Arrival (TDoA, also time of flight)—Distance may be calculated based on signal propagation time. Radio waves travel at a known speed through the wireless medium. Thus, if the time of transmission and time of signal arrival are known, the distance may be computed. Time Difference of Arrival (TDoA) is an example of such a technique. In TDoA, the position may be computed based on the difference in time when the signal arrives at different mobile nodes 100.

Angle (AoA)—Instead of timing information, angles may be used to calculate the position. At each access point, the wireless signal arrives at a certain angle. By using geometric relationships between the angle of arrival at two mobile nodes 100, the estimated location may be computed.

Triangulation and Trilateration,—When the location is estimated based on angle measurements from three or more mobile nodes 100 the method is referred to as triangulation. The signal strength or timing information from several access points may also be used together to form coverage circles and intersection points. If the distance from at least three different mobile nodes 100 may be calculated, this technique is known as trilateration. With the use of algorithms, the devices 110 most likely position may be pointed based on the information from the different mobile nodes 100. The more mobile nodes 100 that contribute in computing the location, the more likely it is to get an accurate approximation.

Location Patterning—None of the above position determination techniques take into account signal propagation characteristics, such as reflection, attenuation and multi-path fading. However, with the location patterning technique, such characteristics of the actual wireless medium considered in the position computation. This location patterning technique may need calibration, in order to record how the wireless signals propagate throughout the environment. During this calibration phase, RF characteristics and real world data regarding how obstacles affect the propagation may be collected and pre-stored in a database. This information may then be compared with real-time information from the mobile nodes 100 to achieve a more accurate position approximation.

Multiple Range Estimation Locator MREL (Multiple Range Estimation Location) used with Andrews Location Measurement Units (LMUs). MREL may use the transmission time and the time of arrival of the signal to determine a circular range ring, where the device 110 may be located. The location may then estimated by the best intersection of the multiple range-rings. Conversely, TDoA calculates the difference in the time of arrival of the mobile signal between multiple pairs of receivers. The differences in arrival time determine hyperbolic curves between receivers of where the device 110 may be. The location may then be estimated by the best intersection of the multiple hyperbolic curves.

In an embodiment, distance or position may be determined by usage of at least one of: association or signal strength, timing information, Received Signal Strength Indication (RSSI), Link Quality Indicator (LQI), Time Difference of Arrival/Time-of-Arrival (TDoA/TOA), Angle (AoA), Triangulation and/or Trilateration, Location Patterning, Multiple Range Estimation Locator MREL (Multiple Range Estimation Location), in combination with anyone else of the mentioned solutions.

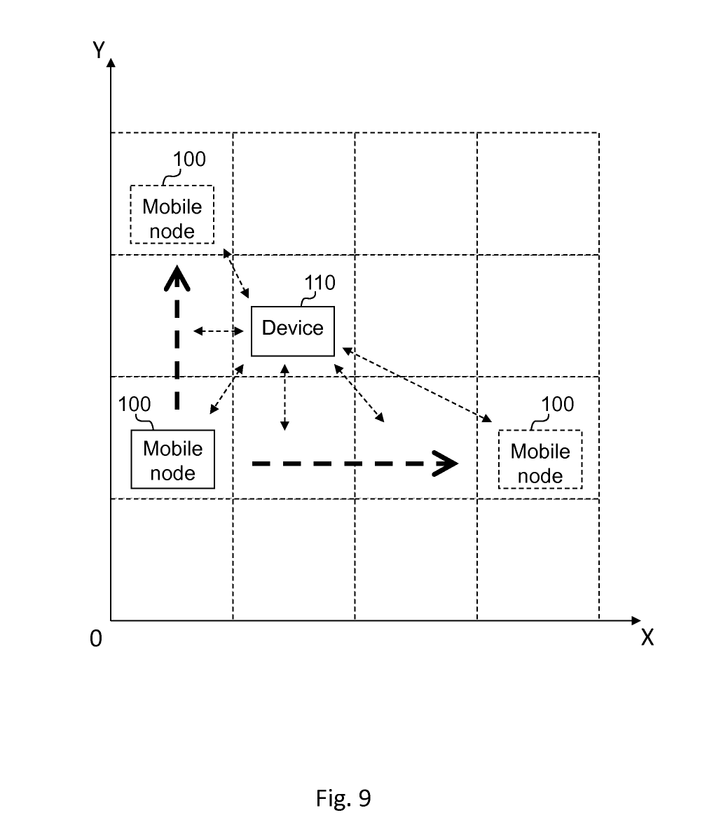

FIG. 9 illustrates an embodiment of the solution. A mobile node 100 may be relocated to different positions. The different positions may be represented in a coordinate system. An example is where the start point of the mobile node 100 is determined as coordinate “0”. When the mobile node 100 is relocated and at each point where a signal is received from the device 110, the new coordinate is determined. There by it may be possible to by usage of one mobile node 100 simulate a plurality of mobile nodes 100, where the simulated plurality of mobile nodes 100 may better determine a position of a device 110, than a single mobile node 100. A mobile node 100 may determine its coordinate by use of GPS, etc. The mobile node 100 may also determine a relative coordinate by usage of for example one of gyro, magnetic compass, accelerometer, tilt sensor, gyroscope, altimeter, not limiting to other type of sensors for measuring movements and/or relative positions.

In an embodiment, not shown in FIG. 9, the coordinate system may be a three dimensional coordinate system, such when a mobile node 100 is relocated and during the relocation determines three dimensional coordinates for each signal received from the device 110.

A user of a mobile node 100 may by moving around, simulate a group of users where each user has a mobile node 100, thereby it may be possible to better determine a position of a device 110 than with a single mobile node 100 stationary at one point.

In an embodiment, the time difference of arrival is measured by the device 110, instead of the mobile node 100. An illustrative example is where at least one mobile node 100 transmits a signal, such an alert signal or any other signal, such that the device 110 may measure the time of flight from the mobile node 100 to the device 110. The device 110 may transmit the response to the alert signal, or any other signal, the response including the identification of the device 110 and also the measured transmission time between the mobile node 100 and the device 110. The device 110 may additionally, based on the measured transmission time between the mobile node 100 and the device 110, determine the distance between the mobile node 100 and the device 110. The response transmitted by the device 110 may then include: identification of the device 110, measured transmission time between the mobile node 100 and the device 110, and the determined distance between the mobile node 100 and the device 110. In an embodiment, the time may be measured with an accuracy down to microseconds. In another embodiment, the time may be measured with an accuracy down to nanoseconds.

There may be advantages with the device 110 measuring the time of arrival, time difference of arrival or time of flight, instead of the mobile node 100. An advantage may be that the device 110 may be easier to adopt for measuring the signals time of flight, than adopting the mobile node 100 for measuring the time. Another advantage may be that the device 110 may be adapted to measure time with a better accuracy. Another advantage may be that by performing measurement in the device, more mobile nodes 100 may participate in positioning a device 110 with a better accuracy then only mobile nodes 100 with support for measuring the time. Another advantage with measuring time in the device 110 is that a plurality of additional sources for determination of the distance between a mobile terminal and a device 110 may enable avoidance of signal reflections and other disturbances.

In a situation where there are a plurality of mobile nodes 100, the device 100 may transmit a response to each mobile node 100, from which the device 100 has received a valid identification. The response may include any of: the identification, measured transmission time, and determined distance. The plurality of mobile nodes 100 may better determine the position of the device 110.

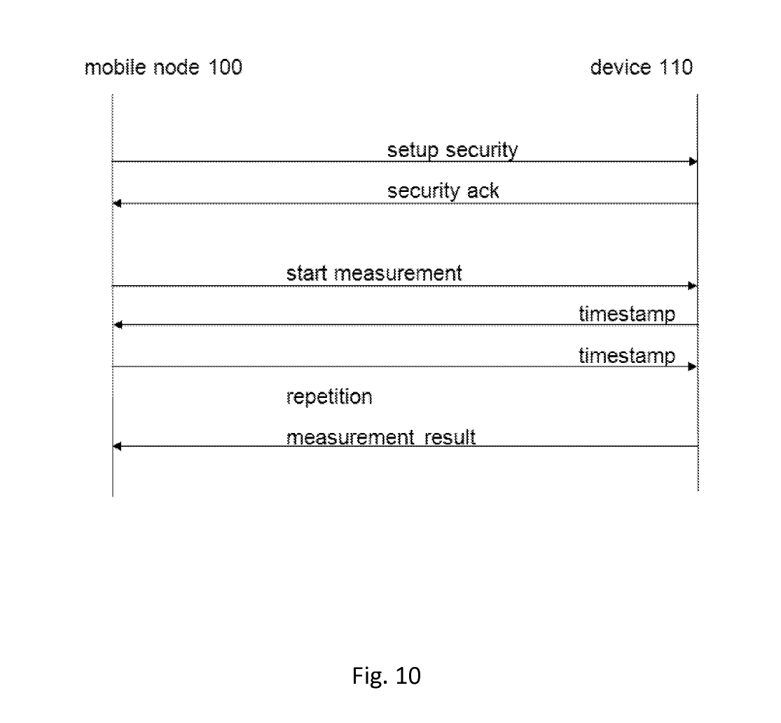

FIG. 10 illustrates an example of an embodiment of a signaling diagram. The mobile node 100 may transmit the alert signal to the device 110, including the identification. The alert signal may be denoted “setup security”. The device 110 may respond with the identification of the device 110. The response from the device 110 may also be denoted “security ack”. The alert signal from the mobile node 100 to the device 110 and the response from the device 110 to the mobile node 100 may as well be a pre-step to the setup security and security ack. An instruction may be transmitted from the mobile node 100 to the device 110, the instruction to start measurement. The device 110 may respond with transmission of a time stamped signal, followed by the mobile node 100 return to that signal, such that the device 110 can measure the time between the device 110 and the mobile node 100, or measure the roundtrip time. The measurement may be repeated until a robust average measurement has been achieved. A final step may be transmission of the measured result from the device 110 to the mobile node 110. The transmitted result may be an average, or all measurements, or some partial consolidated measurement result.

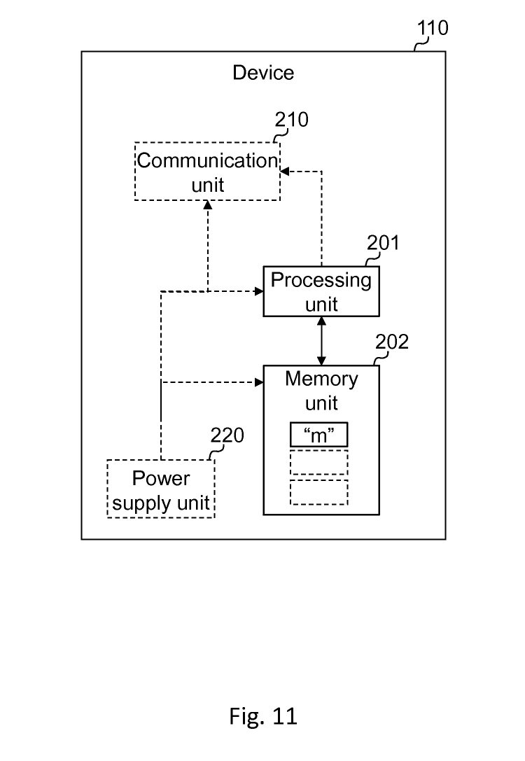

FIG. 11 shows an illustration of embodiments of a device 110. The device 110 may be implemented, by means of program modules of a respective computer program comprising code means which, when run by processing unit 201 causes the device 110 to perform the above-described actions. The processing unit 201 may comprise a single Central Processing Unit (CPU), or could comprise two or more processing units. For example, the processing unit 201 may include general purpose microprocessors, instruction set processors and/or related chips sets and/or special purpose microprocessors such as Application Specific Integrated Circuits (ASICs). The processing unit 201 may also comprise a storage for caching purposes.

Each computer program may be carried by a computer program product 202 in the device 110, shown in FIG. 1, 2, 6, 7, et al, in the form of a memory having a computer readable medium and being connected to the processing unit 201. The computer program product 202 or memory thus comprises a computer readable medium on which the computer program is stored e.g. in the form of computer program modules “m”. For example, the memory 202 may be a flash memory, a Random-Access Memory (RAM), a Read-Only Memory (ROM) or an Electrically Erasable Programmable ROM (EEPROM), and the program modules m could in alternative embodiments be distributed on different computer program products in the form of memories within the device 202.

The device 110 may further comprise a communication unit 210. The communication unit may be arranged to communicate with mobile nodes 100. The communication unit 210 may also be arranged for programming and/or configuration of the device 110. In an embodiment the communication unit 210 may comprise chip set adopted for communication via IEEE 802.11 (Institute of Electrical and Electronics Engineers), including but not limited to 802.11a/b/n or other similar forthcoming standards. Other examples of standards which may be supported by the communication unit 210 are: ZigBee, Bluetooth, RFID (Radio frequency identification), USB (Universal serial bus). The communication unit 210 may comprise an antenna. The communication unit 210 may be connectable to an external antenna.

The device 110 may comprise a power supply unit 220. The power supply unit may be arranged for power supply of: the processing unit 20, the memory unit 202, and/or the communication unit 210. Examples of a power supply unit 220 are, battery, capacitor, fuel cell, solar cell, inductive contact, USB-contact (Universal serial bus), wired contact, not limiting to other examples suitable for a power supply unit 220.

An embodiment of a positioning system according to the solution has been described. However, the person skilled in the art realizes that this may be varied within the scope of the appended claims without departing from the inventive idea.

All the described alternative embodiments above or parts of an embodiment can be freely combined without departing from the inventive idea as long as the combination is not contradictory.

1. A method in a mobile node for enabling determination of a position of a device, the method comprising:
receiving a positioning request message, including an identification of the device,
transmitting an alert signal to the device, including the identification of the device,
receiving a response signal from the device, including the identification of the device, and
calculating a distance or a direction to the device by measuring the received response signal, thereby enabling of determination of the position of the device.

2. The method according to claim 1, wherein
the positioning request message, including an identification of the device is received from a remote node.

3. The method according to claim 1, wherein
a response to the positioning request message including the calculated distance or a direction to the device and a position of the mobile node, is transmitted to a remote node.

4. The method according to claim 1, wherein
the distance to the device is calculated by measuring the signal strength or signal delay.

5. The method according to claim 1, wherein
the direction to the device is calculated by determination of a bearing to a strongest signal strength.

6. The method according to claim 1, wherein
the mobile node receives the response signal from the device in a first receiving device and a second receiving device, wherein the second receiving device is a microphone device.

7. The method according to claim 6, wherein
the microphone device further receives a sound signal from the device.

8. The method according to claim 1, wherein
the mobile node receives the response signal from the device in a third receiving device, wherein
the third receiving device is a separate antenna device mountable to the mobile node.

9. The method according to claim 1, further comprising
repeatedly carrying out the method.

10. A method in a device for enabling determination of a position of the device by a mobile node through at least one wireless network, the method comprising:
receiving an alert signal from the mobile node, including an identification of the device,
alerting the device by matching the received identification with a pre-programmed identification of the device, and
transmitting a response to the alert signal, including the identification of the device matching said received identification, thereby enabling determination of the position of the device.

11. The method according to claim 10, wherein
the response to the alert signal is repeatedly transmitted.

12. The method according to claim 10, wherein
a sound signal is transmitted in response to the alert signal.

13. The method according to claim 10, wherein
the distance to the mobile node is measured by measuring the time of flight.

14. The method according to claim 13, wherein
the measured result is transmitted to the mobile node.

15. A method in a remote node for determination of a position of a device, the method comprising:
transmitting a positioning request message, including an identification of the device, to a plurality of mobile nodes,
receiving at least one response to the positioning request message, including a calculated distance to the device from the mobile node, and a position of the mobile node,
determining a position of the device by calculation of the distance to the device from the mobile node in combination with the position of the at least one mobile device.

16. The method according to claim 15, further comprising
determining whether the position of the device is within a predefined geographical area or volume and/or whether the position of the device is within a predefined distance D from a geographical point.

17. The method according to claim 16, further comprising
transmitting an alarm message to an alarm device upon determining that the position of the device is outside the predefined geographical area or volume and/or whether the position of the device is beyond the predefined distance D from the geographical point.

18. The method according to claim 17, wherein
the alarm device is comprised by at least one of the remote node, the mobile node or the service client.

19. The method according to claim 16, wherein
the geographical point is defined by the location of a mobile node.

20. The method according to claim 15, wherein
the positioning request message is repeatedly transmitted.

21. The method according to claim 15, wherein
when responses to the positioning request messages are received from a plurality of mobile nodes, the position of the device is calculated by use of any of triangulation, or multilateration, or trilateration.

22. The method according to claim 15, wherein
the remote node is hosted by a mobile node.

23. A mobile node arranged to enable determination of a position of a device, wherein:
the mobile node is arranged to receive a positioning request message, including an identification of the device,
the mobile node is arranged to transmit an alert signal to the device, including the identification of the device,
the mobile node is arranged to receive a response signal from the device, including the identification of the device, and
the mobile node is arranged to calculate a distance or a direction to the device by measuring the received response signal, thereby enabling determination of the position of the device.

24. The mobile node according to claim 23, wherein
the mobile node is arranged to receive the positioning request message, including an identification of the device from a remote node.

25. The mobile node according to claim 23, wherein
the mobile node is arranged to transmit a response to the positioning request message including the calculated distance or a direction to the device and a position of the mobile node, to the remote node.

26. The mobile node according to claim 23, wherein
the distance to the device is calculated by measuring the signal strength or signal delay.

27. The mobile node according to claim 23, wherein
the direction to the device is calculated by determination of a bearing to a strongest signal strength.

28. The mobile node according to claim 23, wherein
the node is arranged to receive the response signal from the device in a first receiving device and a second receiving device, wherein the second receiving device is a microphone device.

29. The mobile node according to claim 28, wherein
the response signal from the device comprises a sound signal, received by the microphone device.

30. The mobile node according to claim 23, wherein
a third receiving device is arranged to receive the response signal from the device, wherein the third receiving device is a separate antenna device mountable to the mobile node.

31. A device arranged to enable determination of a position of the device by a mobile node over at least one wireless network, wherein:
the device is arranged to receive an alert signal from the mobile node, including an identification of the device,
the device is arranged to alert the device by matching the received identification with a pre-programmed identification of the device,
the device is arranged to transmit a response to the alert signal, including the identification of the device matching said received identification, thereby enabling determination of the position of the device.

32. The device according to claim 31, wherein
the device is arranged to repeatedly transmit the response to the alert signal.

33. The device according to claim 31, wherein
the device is arranged to transmit a sound signal in response to the alert signal.

34. The device according to claim 31, wherein
the device is arranged to measure the distance to the mobile node by measuring the time of flight.

35. The device according to claim 34, wherein
the device is arranged to transmit the measured result to the mobile node.

36. A remote node arranged to determine a position of a device, wherein:
the remote node is arranged to transmit a positioning request message, including an identification of the device, to a plurality of mobile nodes,
the remote node is arranged to receive at least one response to the positioning request message, including a calculated distance to the device from the mobile node, and a position of the mobile node,
the remote node is arranged to determine a position of the device by calculation of the distance to the device from the mobile node in combination with the position of the at least one mobile node.

37. The remote node according to claim 36, wherein
the remote node is arranged to determine whether the position of the device is within a predefined geographical area or volume and/or whether the position of the device is within a predefined distance D from a geographical point.

38. The remote node according to claim 36, wherein
the remote node is arranged to transmit an alarm message to an alarm device upon determining that the position of the device is outside a predefined geographical area or volume and/or whether the position of the device is beyond a predefined distance D from a geographical point.

39. The remote node according to claim 38, wherein
the alarm device comprises at least one of the remote node, the mobile node or the device.

40. The remote node according to claim 37, wherein
the geographical point is defined by the location of a mobile node.

41. The remote node according to claim 36, wherein
the remote node is arranged to repeatedly transmit a positioning request message.

42. The remote node according to claim 36, wherein
the remote node is arranged to calculate the position of the device by use of any of triangulation, or multilateration, or trilateration when responses to the positioning request messages are received from a plurality of mobile nodes.

43. The remote node according to claim 36, wherein
the remote node is hosted by a mobile node.

44. A computer program, comprising computer readable code means, which when run in a mobile node arranged to enable determination of a position of a device according to claim 23 causes the mobile node arranged to enable determination of a position of a device to perform the corresponding method according to claim 1.

45. A computer program product, comprising a computer readable medium and a computer program according to claim 44, wherein the computer program is stored on the computer readable medium.

46. A computer program, comprising computer readable code means, which when run in a device arranged to enable determination of a position of the device by a mobile node according to claim 31 causes the device arranged to enable determination of a position of the device by a mobile node to perform the corresponding method according to claim 10.

47. A computer program product, comprising a computer readable medium and a computer program according to claim 46, wherein the computer program is stored on the computer readable medium.

48. A computer program, comprising computer readable code means, which when run in a remote node arranged to determine a position of a device according to claim 36 causes the remote node arranged to determine a position of a device to perform the corresponding method according to claim 15.

49. A computer program product, comprising a computer readable medium and a computer program according to claim 48, wherein the computer program is stored on the computer readable medium.
